(19) United States
(12) Patent Application Publication
(10) Pub. No.: US 2024/0354136 A1
(43) Pub. Date: Oct. 24, 2024

(54) SCALABLE VOLUMES FOR CONTAINERS IN A VIRTUALIZED ENVIRONMENT

(71) Applicant: VMware LLC, Palo Alto, CA (US)

(72) Inventor: Kashish BHATIA, Bangalore (IN)

(21) Appl. No.: 18/302,403

(22) Filed: Apr. 18, 2023

(51) Int. Cl. G06F 9/455; G06F 3/06

(52) U.S. Cl. CPC G06F 9/45558; G06F 3/0604; G06F 3/0655; G06F 3/0673; G06F 2009/45579; G06F 2009/45583

(57) ABSTRACT

The disclosure provides an approach for scalable volumes of stateful containers in a virtual environment. A method includes detecting a size change of an existing storage volume for a container running on a host; checking a volume mapping table to determine a size of the existing storage volume; computing a difference between the changed size of the existing storage volume and the size of the existing storage volume in the volume mapping table; creating a storage volume for the container, wherein the size of the created storage volume is at least equal to the difference; and adding an identifier of the container, an identifier of the existing storage volume, an identifier of the created storage volume, and a size of the created storage volume, to an entry in the volume mapping table.

### BACKGROUND

Computer virtualization is a technique that involves encapsulating a physical computing machine platform into virtual machine(s) (VM(s)) executing under control of virtualization software on a hardware computing platform or “host.” A VM provides virtual hardware abstractions for processor, memory, storage, and the like to a guest operating system (OS). The virtualization software, also referred to as a “hypervisor,” may include one or more virtual machine monitors (VMMs) to provide execution environment(s) for the VM(s).

Software defined networks (SDNs) involve physical host computers in communication over a physical network infrastructure of a data center (e.g., an on-premise data center or a cloud data center). The physical network to which the plurality of physical hosts are connected may be referred to as an underlay network. Each host computer may include one or more virtualized endpoints such as VMs, data compute nodes, isolated user space instances, namespace containers (e.g., Docker containers), or other virtual computing instances (VCIs), that communicate with one another over logical network(s), such as logical overlay network(s), that are decoupled from the underlying physical network infrastructure and use tunneling protocols.

Applications today are deployed onto a combination of VMs, containers, application services, and more. While VMs virtualize physical hardware, containers may virtualize the OS. Containers may be more portable and efficient than VMs. VMs are an abstraction of physical hardware that can allow one server to function as many servers. The hypervisor allows multiple VMs to run on a single host. Each VM includes a full copy of an OS, one or more applications, and necessary binaries and libraries. Containers are an abstraction at the application layer that packages code and dependencies together. Multiple containers can run on the same host or virtual machine and share the OS kernel with other containers, each running as isolated processes in user space. Containers may take up less space than VMs. For example, container images may be around tens of megabytes (MBs) in size as compared to VM images that can take up to tens of gigabytes (GBs) of space. Thus, containers may be faster to boot than VMs, can handle more applications, and require fewer VMs and OSs.

Containers can be logically grouped and deployed in VMs. While some containers are stateless, many modern services and applications require stateful containers. A stateless container is one that does not retain persistent data. A stateful container, such as a database, retains persistent storage.

Today, with widespread adoption of clouds and software-as-a-service (SaaS) platforms, containers not only need to be stateful, but also scalable. For example, a persistent volume may be created for a stateful container and later, based on the cloud application workload, there can be a need to have more persistent storage and, hence, a larger volume for a container.

While stateless containers are easy to scale, stateful containers are more difficult to scale. In one example, to scale a single volume, a new container is created with a larger volume and the application is transferred from the existing container to the new container. The old container is then discarded. This approach is time consuming because the transfer from the old container to the new container is not straightforward and requires extra resource overhead.

Accordingly, what is needed are techniques for scalable volumes for containers in a virtualized environment.

### SUMMARY

The technology described herein provides for scalable container volumes in a virtualized environment.

A method includes detecting a size change of an existing storage volume for a container running on a host; checking a volume mapping table to determine a size of the existing storage volume; computing a difference between the changed size of the existing storage volume and the size of the existing storage volume in the volume mapping table; creating a storage volume for the container, wherein the size of the created storage volume is at least equal to the difference; and adding an identifier of the container, an identifier of the existing storage volume, an identifier of the created storage volume, and a size of the created storage volume, to an entry in the volume mapping table.

Further embodiments include a non-transitory computer-readable storage medium storing instructions that, when executed by a computer system, cause the computer system to perform the method set forth above, and a computer system including at least one processor and memory configured to carry out the method set forth above.

### BRIEF DESCRIPTION OF THE DRAWINGS

FIG. 1 depicts a block diagram of a data center in a network environment, according to one or more embodiments.

FIG. 2 is a block diagram of a pod VM running one or more containers and storage for the container volumes, according to one or more embodiments.

FIG. 3 is a block diagram of a pod VM running two containers and storage for the container volumes with a volume mapping table and logical block address (LBA) table for container volume expansion, according to one or more embodiments.

FIG. 4 depicts a block diagram of a workflow for container volume expansion, according to one or more embodiments.

FIG. 5 depicts a block diagram of a workflow for handling input/output (I/O) requests, according to one or more embodiments.

FIG. 6 depicts a flow diagram illustrating example operations for container volume expansion, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for scalable volumes for containers in a virtualized environment. In some embodiments, the techniques for scalable volumes described herein allow for online expansion of existing container volumes without bringing the down the container applications running in the virtualized environment. Accordingly, containers in the virtualized environment can be scaled without compromising consistency and with reduced resource overhead. As used herein, a delta persistent volume created for container is referred to as a delta disk.

In some embodiments, when a container volume is created for a container, the identifier of the container, the identifier of the container volume, and the size of the container volume are added to a volume mapping table.

In some embodiments, the identifier of the container volume is added to a virtual LBA table that contains LBA to virtual block address (VBA) mappings associated with the container volume. Volumes associated with a container reside in a virtual disks. As used herein, the VBA refers to the bock addressing associated with the virtual disks. The virtual disks reside on physical storage attached to the hypervisor. The physical storage uses physical block addressing. Accordingly, the hypervisor further maintains a mapping of LBAs to PBAs.

In some embodiments, the system polls a configuration file to detect when a change in size to a container volume is made. For example, a user may update a configuration for the container to increase a size of the container volume (or such an update may be triggered by some other process), and the update may cause the configuration file to change accordingly. In some embodiments, the size of the changed container volume in the configuration file is compared to the size of the container volume in the volume mapping table to determine the size for a “delta” container volume to be created. For example, the delta container volume may have a size that is equal to the difference between the changed container volume in the configuration file and the size of the container volume in the volume mapping table. In some embodiments, the delta container volume is created as a child volume of the container volume and the container volume therefore becomes a parent volume of the delta container volume. The volume mapping table may then be updated to include (e.g., in a new entry) a mapping between the identifier of the container, the identifier of the container volume (the parent volume) the identifier of the delta disk container volume, and the size of the delta disk container volume. It is noted that in some embodiments even before a delta volume is created the entry in the volume mapping table for the original container volume includes a mapping between the identifier of the container, a parent volume identifier, a delta disk volume identifier, and a volume size indicator. In such embodiments, if only a single container volume has been created (e.g., before the delta container volume is created) both the parent volume identifier and the delta disk volume identifier may be set to the identifier of the single container volume and the volume size indicator may be set to the size of the single container volume. Then, in such embodiments, after the creation of the delta container volume, a new entry may be created in the volume mapping table in which the parent volume identifier is set to the identifier of the container volume, the delta disk volume identifier is set to the identifier of the delta container volume, and the volume size indicator is set to the size of the delta container volume.

In certain embodiments, after a delta container volume is created, the identifier of the delta container volume is added to the virtual LBA table with the associated LBA to VBA mappings.

In some embodiments, when an I/O request is received from a container, the system determines an LBA associated with the I/O request, checks the virtual LBA table to identify the VBA and the container storage volume associated with the LBA and then checks the volume mapping table for an entry containing the identifier of the container and the identifier of the container storage volume associated with the LBA to verify whether the container can access the container storage volume.

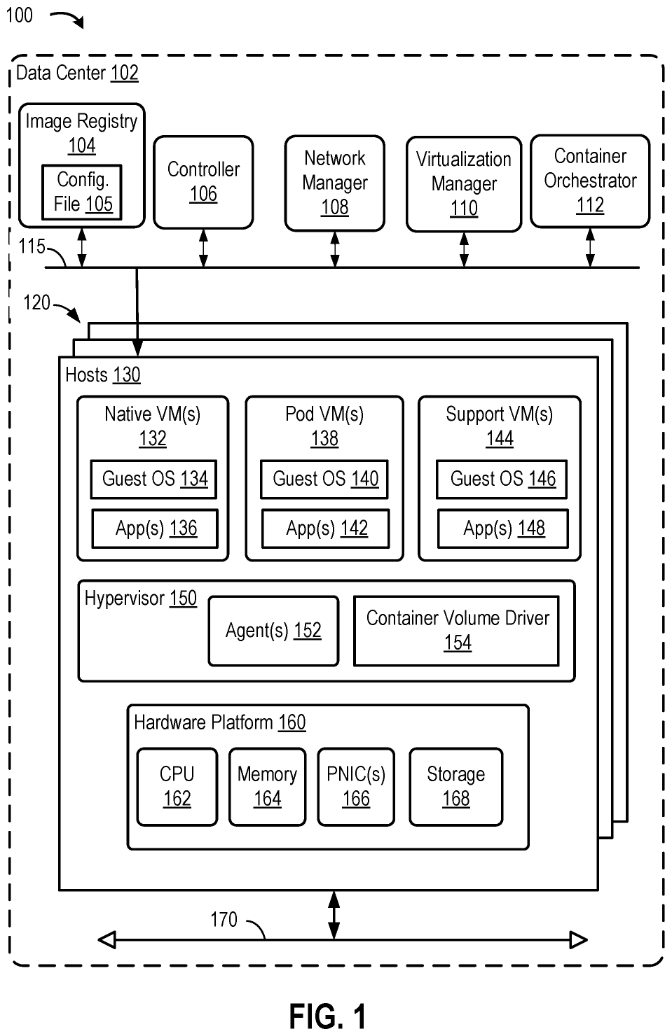

FIG. 1 depicts example physical and virtual network components in a networking environment 100 in which embodiments of the present disclosure may be implemented.

Networking environment 100 includes a data center 102. Data center 102 includes an image registry 104, a controller 106, a network manager 108, a virtualization manager 110, a container orchestrator 112, a management network 115, one or more host clusters 120, and a data network 170

A host cluster 120 includes one or more hosts 130. Hosts 130 may be communicatively connected to data network 170 and management network 115. Data network 170 and management network 115 are also referred to as physical or “underlay” networks, and may be separate physical networks or may be the same physical network with separate virtual local area networks (VLANs). As used herein, the term “underlay” may be synonymous with “physical” and refers to physical components of networking environment 100. Underlay networks typically support Layer 3 (L3) routing based network addresses (e.g., Internet Protocol (IP) addresses).

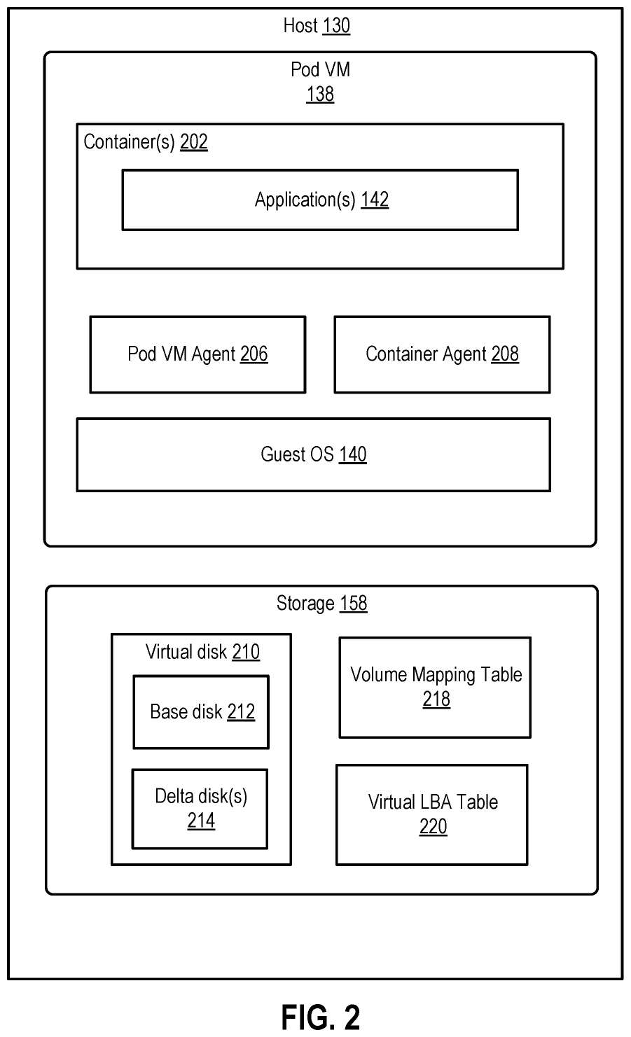

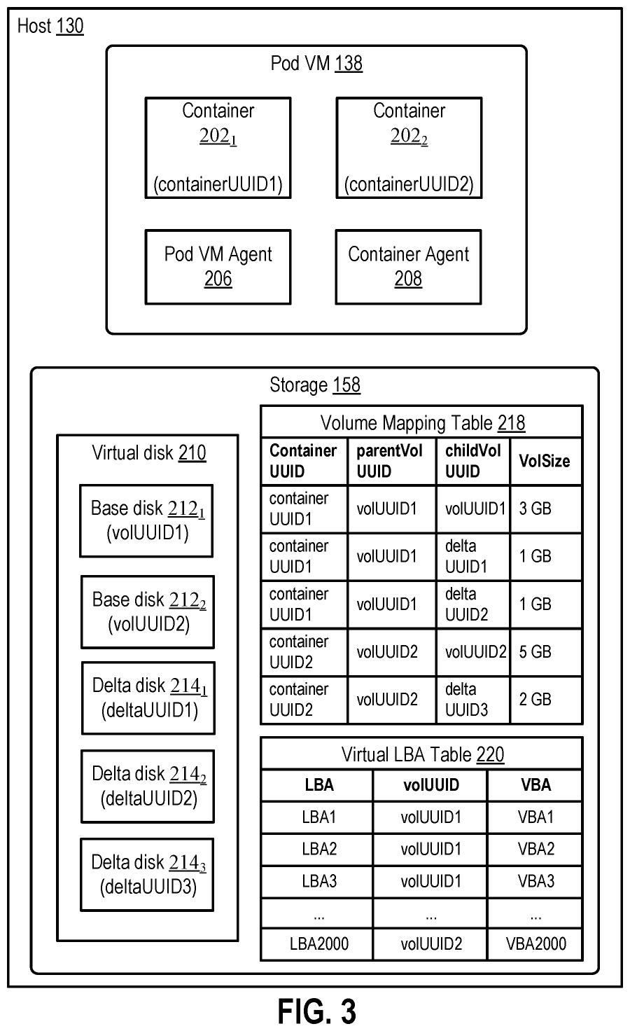

Hosts 130 may be geographically co-located servers on the same rack or on different racks in any arbitrary location in the data center. Host(s) 130 are configured to provide a virtualization layer, also referred to as a hypervisor 150, that abstracts processor, memory, storage, and networking resources of a hardware platform 160 into multiple VMs (e.g., native VMs 132, pod VMs 138, and support VMs 144). Each VM (e.g., native VM(s) 132, pod VM(s) 138, and support VM(s) 144) includes a guest OS (e.g., guest OSs 134, 140, and 146, respectively) and one or more applications (e.g., application(s) 136, 142, and 148, respectively). The guest OS may be a standard OS and the applications may run on top of the guest OS. An application may be any software program, such as a word processing program, a virtual desktop interface (VDI), or other software program. The applications can includes containerized applications executing in pod VMs 138 and non-containerized applications executing directly on guest OSs in in native VMs 132. Support VMs 144 have specific functions within host cluster 120. For example, support VMs 144 can provide control plane functions, edge transport functions, and/or the like Pod VMs 138 are described in more detail herein with respect to FIGS. 2-3.

Host(s) 130 may be constructed on a server grade hardware platform 160, such as an x86 architecture platform. Hardware platform 160 of a host 130 may include components of a computing device such as one or more central processing units (CPUs) 162, memory 164, one or more physical network interfaces (PNICs) 166, storage 168, and other components (not shown). A CPU 162 is configured to execute instructions, for example, executable instructions that perform one or more operations described herein and that may be stored in memory 164 and storage 168. PNICs 166 enable host 130 to communicate with other devices via a physical network, such as management network 115 and data network 170.

Memory 164 is hardware allowing information, such as executable instructions, configurations, and other data, to be stored and retrieved. Memory 164 may be volatile memory or non-volatile memory. Volatile or non-persistent memory is memory that needs constant power in order to prevent data from being erased, such as dynamic random access memory (DRAM).

Storage 168 represents persistent, non-volatile memory, storage devices that retains its data after having power cycled (turned off and then back on), which may be byte-addressable, such as one or more hard disks, flash memory modules, solid state disks (SSDs), magnetic disks, optical disks, or other storage devices, as well as combinations thereof. In some embodiments, hosts 130 access a shared storage using PNICs 166. In another embodiment, each host 130 contains a host bus adapter (HBA) through which input/output operations (IOs) are sent to the shared storage (e.g., over a fibre channel (FC) network). A shared storage may include one or more storage arrays, such as a storage area network (SAN), a network attached storage (NAS), or the like. In some embodiments, shared storage 168 is aggregated and provisioned as part of a virtual SAN (vSAN). Storage 168 is described in more detail herein with respect to FIGS. 2-6 according to aspects of the present disclosure.

Hypervisor 150 architecture may vary. Hypervisor 150 can be installed as system level virtualization software directly on the server hardware (often referred to as “bare metal” installation) and be conceptually interposed between the physical hardware and the guest OSs executing in the VMs. Alternatively, the virtualization software may conceptually run “on top of” a conventional host OS in the server. In some implementations, hypervisor 150 may comprise system level software as well as a “Domain 0” or “Root Partition” VM (not shown) which is a privileged machine that has access to the physical hardware resources of the host 130. In this implementation, one or more of a virtual switch, a virtual router, a virtual tunnel endpoint (VTEP), etc., along with hardware drivers, may reside in the privileged VM. One example of hypervisor 150 that may be used is a VMware ESXi™ hypervisor provided as part of the VMware vSphere® solution made commercially available from VMware, Inc. of Palo Alto, California. Hypervisor 150 runs a container volume driver 154. Container volume driver 154 acts as a server to receive requests from a container agent 208 discussed in more detail below with respect to FIG. 2. Container volume driver 154 is responsible for communicating with hypervisor 150 and managing volume expansion of containers as discussed in more detail below with respect to FIGS. 3-6.

Data center 102 includes a management plane and a control plane. The management plane and control plane each may be implemented as single entities (e.g., applications running on a physical or virtual compute instance), or as distributed or clustered applications or components. In alternative embodiments, a combined manager/controller application, server cluster, or distributed application, may implement both management and control functions. In the embodiment shown, network manager 108 at least in part implements the management plane and controller 106 at least in part implements the control plane

The control plane determines the logical overlay network topology and maintains information about network entities such as logical switches, logical routers, and endpoints, etc. As used herein, the term “overlay” may be used synonymously with “logical” and refers to the logical network implemented at least partially within networking environment 100. The logical topology information is translated by the control plane into network configuration data, such as forwarding table entries to populate forwarding tables at virtual switches in each host 130. A virtual switch provided by a host 130 may connect virtualized endpoints running on the same host 130 to each other as well as to virtual endpoints on other hosts. Logical networks typically use Layer 2 (L2) routing based on data link layer addresses (e.g., Medium Access Control (MAC) addresses). The network configuration data is communicated to network elements of host(s) 130.

Controller 106 generally represents a control plane that manages configuration of VMs within data center 102. Controller 106 may be one of multiple controllers executing on various hosts 130 in data center 102 that together implement the functions of the control plane in a distributed manner. Controller 1065 may be a computer program that resides and executes in a server in data center 102, external to data center 102 (e.g., in a public cloud), or, alternatively, controller 106 may run as a virtual appliance (e.g., a VM) in one of the hosts 130. Although shown as a single unit, it should be understood that controller 106 may be implemented as a distributed or clustered system. That is, controller 106 may include multiple servers or VCIs that implement controller functions. It is also possible for controller 106 and network manager 108 to be combined into a single controller/manager. Controller 106 collects and distributes information about the network from and to endpoints in the network. Controller 106 is associated with one or more virtual and/or physical CPUs (not shown). Processor(s) resources allotted or assigned to controller 106 may be unique to controller 106, or may be shared with other components of data center 102. Controller 106 communicates with hosts 130 via management network 115, such as through control plane protocols. In some embodiments, controller 106 implements a central control plane (CCP).

Network manager 108 and virtualization manager 110 generally represent components of a management plane comprising one or more computing devices responsible for receiving logical network configuration inputs, such as from a user or network administrator, defining one or more endpoints (e.g., VCIs) and the connections between the endpoints, as well as rules governing communications between various endpoints.

In some embodiments, virtualization manager 110 is a computer program that executes in a server in data center 102 (e.g., the same or a different server than the server on which network manager 108 executes), or alternatively, virtualization manager 110 runs in one of the VMs. Virtualization manager 110 is configured to carry out administrative tasks for data center 102, including managing hosts 130, managing VMs running within each host 130, provisioning VMs, transferring VMs from one host 130 to another host, transferring VMs between data centers, transferring application instances between VMs or between hosts 130, and load balancing among hosts 130 within data center 102. Virtualization manager 110 takes commands as to creation, migration, and deletion decisions of VMs and application instances on data center 102. Virtualization manager 110 also makes independent decisions on management of local VMs and application instances, such as placement of VMs and application instances between hosts 130. In some embodiments, virtualization manager 110 also includes a migration component that performs migration of VMs between hosts 130. One example of a virtualization manager 110 is the vCenter Server™ product made available from VMware, Inc. of Palo Alto, California.

In some embodiments, network manager 108 is a computer program that executes in a server in networking environment 100, or alternatively, network manager 108 may run in a VM (e.g., in one of hosts 130). Network manager 108 communicates with host(s) 130 via management network 115. Network manager 108 may receive network configuration input from a user or an administrator and generates desired state data that specifies how a logical network should be implemented in the physical infrastructure of data center 102. Network manager 108 is configured to receive inputs from an administrator or other entity (e.g., via a web interface or application programming interface (API)), and carry out administrative tasks for data center 102, including centralized network management and providing an aggregated system view for a user. One example of a network manager 108 is the NSX™ product made available from VMware, Inc. of Palo Alto, California.

Container orchestrator 112 provides a platform for automating deployment, scaling, and operations of application containers across host cluster(s) 120. In some embodiments, the virtualization layer of a host cluster 120 is integrated with an orchestration control plane. For example, virtualization manager 110 may deploy the container orchestrator 112. The orchestration control plane can include the container orchestrator 112 and agents 152, which may be installed by virtualization manager 110 and/or network manager 108 in hypervisor 150 to add host 130 as a managed entity. Although container orchestrator 112 is shown as a separate logical entity, container orchestrator 112 may be implemented as one or more native VM(s) 132 and/or pod VMs 138. Further, although only one container orchestrator 112 is shown, data center 102 can include more than one container orchestrator 112 in a logical cluster for redundancy and load balancing.

In some systems, containers are grouped into logical units called “pods” that execute on nodes in a cluster (also referred to as “node cluster”). A node can be a physical server or a pod VM 138.

FIG. 2 is a block diagram of a pod VM 138, according to one or more embodiments. Pod VM 138 includes guest OS 140 and a pod VM agent 206 and container agent 208 executing on top of guest OS 140 that supports the containers 202 of the pod. Containers 202 in the same pod share the same resources and the same network, and maintain a degree of isolation from containers in other pods Container agent 208 is a module that allows the pod VM 138 to communicate with the hypervisor 150 and is responsible for sending requests on behalf of the containers 202. Pod VM agent 206 cooperates with container orchestrator 112 that manages the lifecycle of containers 202, such as issuing container creation requests, container deletion requests, and requests for creation of volumes for the containers 202.

Image registry 104 manages images and image repositories for use in supplying images for containerized applications. The containers in pod VMs 138 are spun up from container images managed by image registry 104. In some embodiments, image registry contains configuration file 105. Configuration file 105 stores information for deploying containers and container volumes. In some embodiments, configuration file 105 contains the number of container volumes and the size of the container volumes to be created for each container.

As discussed above, stateful containers (e.g., containers 202) are backed by persistent volumes. The persistent volumes provisioned for containers are carved out from virtual disks. As shown in FIG. 2, pod VM(s) 138 may use virtual disk 210 stored as files on the host 130, for example in storage 158, or on a remote storage device that appears to the guest OS 140 as standard disk drives. Virtual disk 210 may use backing storage contained in a single file or a collection of smaller files. Virtual disk 210 may include a text descriptor that describes the layout of the data in the virtual disk. This descriptor may be saved as a separate file or may be embedded in a file that is part of virtual disk 210. Virtual disk 210 consists of the base disk 213 and one or more delta disk(s) 214. Virtual machine disk (VMDK) is a file format that describes containers for virtual disks to be used in VMs.

Storage 158 further contains a volume mapping table 218 and a virtual LBA table 220 used by container volume driver 154. The use of the volume mapping table 218 and the virtual LBA table 220 in container volume expansion are discussed in more detail herein with respect to FIGS. 3-6. In some embodiments, a virtual LBA table is maintained per container.

Volume mapping table 218 stores a mapping of containers and volumes associated with the containers. In some embodiments, volume mapping table 218 contains entries with an identifier (e.g., a universally unique identifier (UUID)) of a container, an identifier of a parent volume (e.g., an original container volume for the container), an identifier of a delta disk volume (e.g., an expanded or delta container volume for the container), and a volume size. For example, volume mapping table 218 contains entries for the columns <ContainerUUID, parent VolUUID, delta VolUUID, volSize>. When the identifiers of the parent and child volumes for an entry in the volume mapping table 218 are the same, then the container volume is the base volume (e.g., has not been expanded). When the identifiers of the parent and delta disk volumes in the volume mapping table 218 are different, then the associated entry is for a delta volume created after a volume expansion request. In some embodiments, the volume mapping table 218 contains information for all of the containers.

Virtual LBA table 220 stores the addresses of the container volume block for reading or writing to the virtual disk. In some embodiments, virtual LBA table 220 contains entries with an LBA, an identifier of a volume, and a VBA. The identifier of the volume may be the UUID of the volume that contains a block of data, which may be a parent volume or a delta disk volume. The VBA is the virtual block, within the virtual disk where the volume resides, to which the LBA is mapped. In some embodiments, virtual LBA table 220 contains entries for the columns <LBA, volUUID, VBA>.

In some embodiments, hypervisor 150 may manage storage of virtual disks at a block granularity. In some embodiments, storage 158 may be divided into a number of physical blocks (e.g., 4096 bytes or “4K” size blocks), each physical block having a corresponding physical block address (PBA) that indexes the physical block in storage. The physical blocks may be used to store blocks of data (also referred to as data blocks) used by VMs, which may be referenced by LBAs. Blocks of data may be stored as compressed data or uncompressed data such that there may or may not be a one to one correspondence between a physical block and a data block referenced by a LBA. A logical map table may include a mapping of the LBAs to PBAs. In some embodiments, the metadata (e.g., the LBA to PBA mappings) is stored as key-value data structures, such as by using a logical map B+ tree.

FIG. 3 is a block diagram of a pod VM 138 running container 202₁ having containerUUID1 and container 202₂ having containerUUID2. Container 202₁ has base disk 212₁ stored in a volume having volUUID1, a first delta disk 214₁ having deltaUUID1, and a second delta disk 214₂ having deltaUUID2. Container 202₂ has base disk 212₂ stored in a volume having volUUID2 and a third delta disk 214₃ having deltaUUID3.

Accordingly, for containers and volumes illustrated in FIG. 3, volume mapping table 218 includes entries: <containerUUID1, volUUID1, volUUID1, 3 GB> for an original base volume of container 202₁; <containerUUID1, volUUID1, deltaUUID1, 1 GB> for a first delta disk expansion of the container 202₁ volume; <containerUUID1, volUUID1, deltaUUID2, 1 GB> for a second delta disk expansion of the container 202₁ volume; <containerUUID2, volUUID2, volUUID2, 5 GB> for an original base volume of container 202₂; and <containerUUID2, volUUID2, deltaUUID3, 1 GB> for a first delta disk expansion of the container 202₂ volume. Virtual LBA table 220 contains entries with the LBA to VBA mappings and the associated volume UUIDs indicating the physical block locations for those volumes.

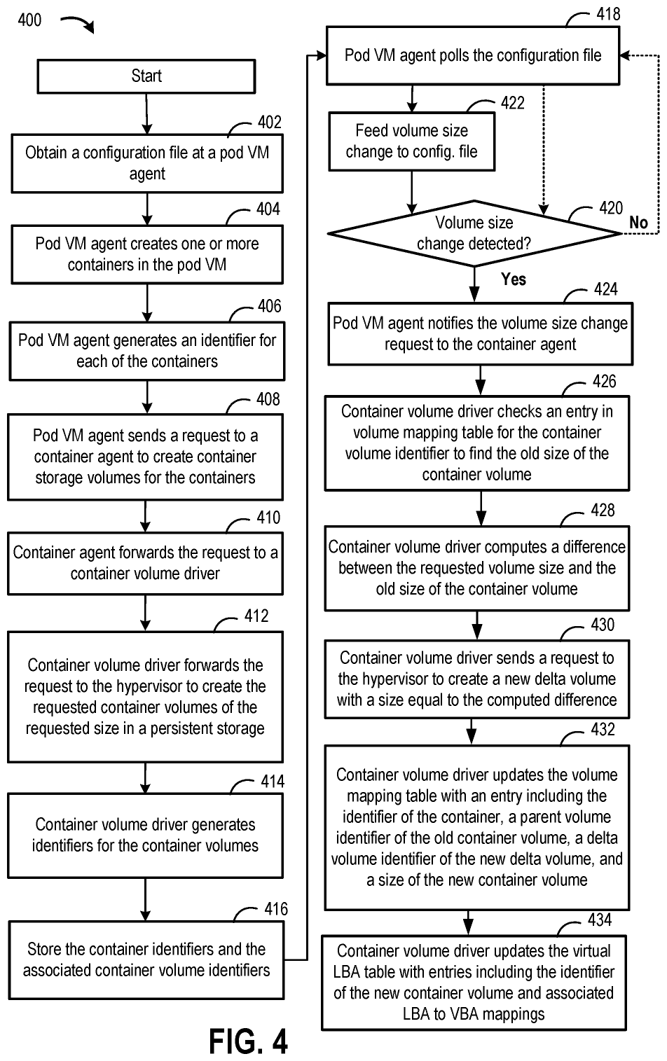

FIG. 4 depicts a block diagram of a workflow 400 for container volume expansion, according to one or more embodiments. The workflow 400 may be understood with reference to the example host 130 illustrated in FIG. 3.

As shown, workflow 400 includes, at step 402, obtaining, by the pod VM agent 206, the configuration file 105.

Based on the configuration file 105, the pod VM agent 206 creates containers 202 in pod VM 138 at step 404. In some embodiments, a pod VM agent 206 in one VM creates a cluster of containers across multiple VMs. In the example illustrated in FIG. 3, the pod VM agent 206 creates container 202₁ and container 202₂ in pod VM 138.

At step 406, pod VM agent 206 generates an identifier (e.g., a UUID) for each container 202 after creation of the container. In the example illustrated in FIG. 3, the pod VM agent 206 generates containerUUID1 for the container 202₁ and containerUUID2 for the container 202₂.

For creation of container storage, pod VM agent 206 sends a request to container agent 208 at step 408. In some embodiments, the request includes information from the configuration file 105, such as a number of container volumes, a size of the container volumes, and the UUIDs for the containers 202.

At step 410, container agent 208 forwards the container storage request to the container volume driver 154.

At step 412, the container volume driver 154 forwards the container storage request to the hypervisor 150 to create the requested volumes of the requested size in persistent storage. In the example illustrated in FIG. 3, the hypervisor 150 creates the base disk 212₁ with the size 3 GB for the container 202₁ and the base disk 212₂ with the size 5 GB for the container 202₂.

At step 414, the container volume driver 154 generates identifiers (e.g., UUIDs) for the container volumes. In the example illustrated in FIG. 3, the container volume driver 154 generates volUUID1 for the base disk 212₁ and volUUID2 for the base disk 212₂.

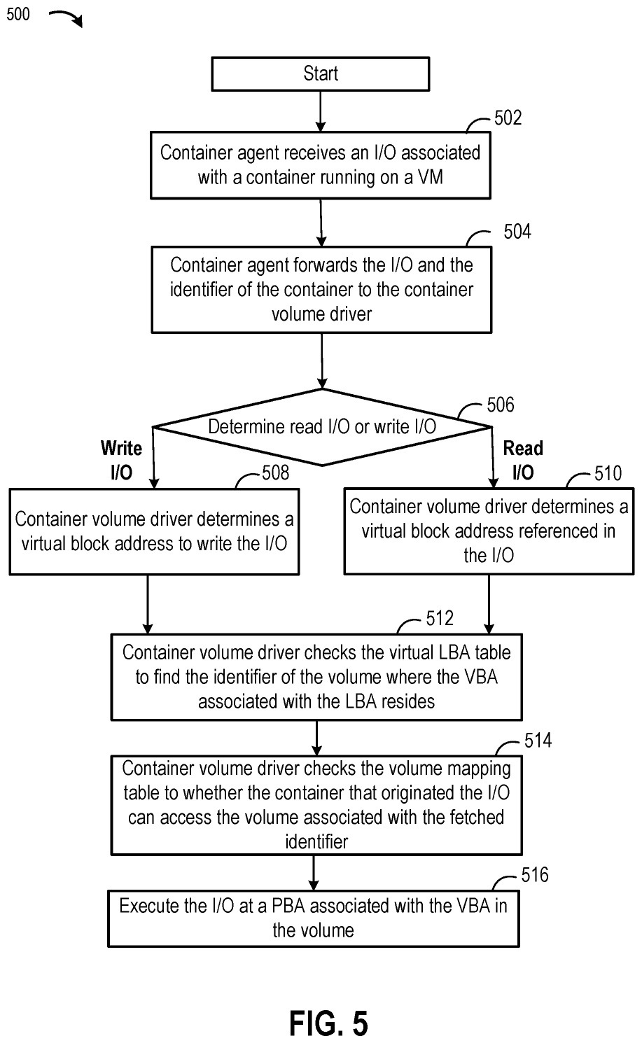

At step 416, the container volume driver 154 stores the identifier(s) of the container(s) and the associated identifier(s) of the container volume(s). In some embodiments, the container volume driver 154 book keeps the containerUUID and volUUID for further use in I/O operations as discussed in more detail below with respect to FIG. 5.

In some embodiments, book keeping the containerUUID and volUUID includes updating or creating the volume mapping table 218 with the container ID, a parent volume ID, a delta disk volume ID, and the volume size, where the parent volume ID and the child volume ID are the same for the base disk creation and different when a delta disk is created. In the example illustrated in FIG. 3, the container volume driver 154 stores the containerUUID1 and the associated volUUID1 as the parent volume ID and also as the delta disk volume ID for the base disk 212₁ in the volume mapping table 218. Container volume driver 154 stores the containerUUID2 and the associated volUUID2 as the parent volume ID and the delta disk volume ID for the base disk 212₂. In some embodiments, book keeping the volUUID also includes updating the virtual LBA table 220 with LBA to VBA mappings associated with the volUUID.

In some embodiments, at step 418, pod VM agent 206 polls configuration file 105. In some embodiments, pod VM agent 206 contains a polling thread that polls (e.g., continuously, periodically, or based on a trigger) image registry 104 for the configuration file 105 to detect changes made in the configuration file 105. In some embodiments, a command line interface (CLI) may be used to specify a volume size change directly (e.g., in addition to or alternatively to polling a configuration file).

At step 420, pod VM agent 206 detects whether a volume size change has occurred in configuration file 105. As shown in FIG. 4, if no changes are detected, workflow 400 may return to step 418 and pod VM agent 206 may continue polling configuration file 105.

At step 422, a change in volume size for a container is fed into the configuration file 105 (e.g., by a user or administrator). In the example illustrated in FIG. 3, container 202₁ uses 5 GB-3 GB volUUID1 for base disk 212₁, 1 GB deltaUUID1 for delta disk 214₁, and 1 GB deltaUUID2 for delta disk 214₂—and may need to expand by an additional 2 GB (e.g., to 7 GB total size). In this example, the 2 GB additional volume (or the 7 GB total volume) is fed to the configuration file 105. Accordingly, pod VM agent 206 may detect the volume size change at step 420 after polling the updated configuration file 105 at step 418.

At step 424, when pod VM agent 206 detects a volume size change in configuration file 105, pod VM agent 206 notifies a volume size change request to container agent 208. In some embodiments, the volume size change request includes the identifier of the container, the identifier of the associated container volume being expanded, and the requested size of the container volume. For example, the pod VM agent 206 may send <containerUUID, volUUID, newSize> to the container agent 208. In the example discussed herein with respect to FIG. 3, the pod VM agent 206 may send <containerUUID1, volUUID1, 5 GB> to the container agent 208. In some embodiments, the container agent 208 forwards the volume size change request to the container volume driver 154. While volUUID1 (the base disk) is being expanded, and is the parent disk, in this example, in other embodiments, the delta disks, deltaUUID1 or deltaUUID2 may be expanded and may be a parent disk.

At step 426, container volume driver 154 checks the entry in the volume mapping table 218 for the identifier of the container volume in the volume size change request to find the old size for the container volume. In the example discussed herein with respect to FIG. 3, container volume driver 154 checks volume mapping table 218 for volUUID1 and finds the old size of the volUUID1, 3 GB.

At step 428, container volume driver 154 computes a difference between the requested volume size and old size of the container volume. In some embodiments, container volume driver 154 computes diffSize=newSize−oldSize. In the example discussed herein with respect to FIG. 3, container volume driver 154 computes 2 GB (i.e., the requested volume size of 5 GB−the old volume size 3 GB=2 GB).

At step 430, container volume driver 154 sends a volume creation request to the hypervisor 150 to create a new delta volume with a size equal to the computed difference. In some embodiments, the volume creation request includes diffSize. In the example discussed herein with respect to FIG. 3, container volume driver 154 sends a volume creation request to hypervisor 150 and includes the computed diffSize=2 GB and hypervisor 150 creates a new delta volume (e.g., delta disk 214₄ with deltaUUID4, not shown).

At step 432, container volume driver 154 updates volume mapping table 218 with an entry including the identifier of the expanded container, a parent volume identifier of the old container volume, a delta disk volume identifier of the new container volume, and a size of the new container volume. In the example discussed herein with respect to FIG. 3, container volume driver 154 updates volume mapping table 218 with an entry containing the containerUUID1 for the expanded container 202₁, volUUID1 as the parent volume (the base disk 212₁), deltaUUID4 as the delta disk volume (the newly created delta disk 214₄), and 2 GB as the volume size of the newly created delta disk 214₄ (e.g., <containerUUID1, volUUID1, deltaUUID4, 2 GB>).

At step 434, container volume driver 154 updates the virtual LBA table 220 with the identifier of the new container volume and the associated LBA to VBA mappings. In the example discussed herein with respect to FIG. 3, container volume driver 154 updates the virtual LBA table 220 with entries containing deltaUUID4 and the associated LBA to VBA mappings (not shown).

FIG. 5 depicts a block diagram of a workflow 500 for handling read and write input/output requests, according to one or more embodiments. The workflow 500 may be understood with reference to the example host 130 illustrated in FIG. 3.

At step 502, container agent 208 receives an I/O associated with a container 202 on pod VM 138. In the example discussed herein with respect to FIG. 3, container agent 208 may receive an I/O associated with the container 202₁.

At step 504, container agent 208 forwards the I/O to container volume driver 154 along with the identifier of the container that originated the I/O. In the example discussed herein with respect to FIG. 3, container agent 208 forwards the I/O and the containerUUID1 associated with the container 202₁ to container volume driver 154.

At step 506, container volume driver 154 determines whether the I/O is read I/O or a write I/O.

At step 508, for a write I/O, container volume driver 154 determines a virtual address of a block where the write I/O should be written. For example, container volume driver 154 includes a block allocation module that makes the determination of the LBA where the write I/O should be written.

At step 510, for read I/O, container volume driver 154 determines a virtual address of a block referenced in the read I/O.

At step 512, container volume driver 154 checks the virtual LBA table 220 to fetch the identifier of the volume where the VBA associated with the LBA resides. The container volume may be a base disk or a delta disk volume. In the example discussed herein with respect to FIG. 3, a read or write I/O may be from or to VBA3 that is located in base disk 212₁ with the volUUID1 and, in this example, container volume driver 154 fetches volUUID1.

At step 514, container volume driver 154 checks the volume mapping table 218 to validate whether the container that originated the I/O can access the volume associated with the fetched identifier. For example, the container volume driver 154 checks whether an entry exists in the volume mapping table 218 with the fetched volume identifier and the container identifier. In the example discussed herein with respect to FIG. 3, container volume driver 154 may check whether the volume mapping table 218 contains an entry with the containerUUID1 associated with the container 202₁ and with the volUUID1 of the base disk 212₁ volume. Accordingly, container volume driver 154 determines that the container 202₁, which originated the I/O, can access the volume, base disk 212₁, containing the VBA3. In some embodiments, where container volume driver 154 determines that a container cannot access the volume, an error may be returned to container agent 206 and forwarded to the application issuing the I/O.

At step 516, the container volume driver 154 asks hypervisor 150 to execute the I/O at a PBA associated with the VBA in the volume. In the example discussed herein with respect to FIG. 3, container volume driver 154 asks hypervisor 150 to write the I/O to (for a write I/O) or read the I/O from (for a read I/O) the PBA associated with the VBA3 in the base disk 212₁ volume. In the case of a read, the payload of the read block (e.g., data) is returned to the container that originated the read I/O. In some aspects, hypervisor 150 maintains a mapping of LBAs to PBAs. Accordingly, hypervisor 150 can execute the I/O at the PBA mapped to the LBA associated with the VBA.

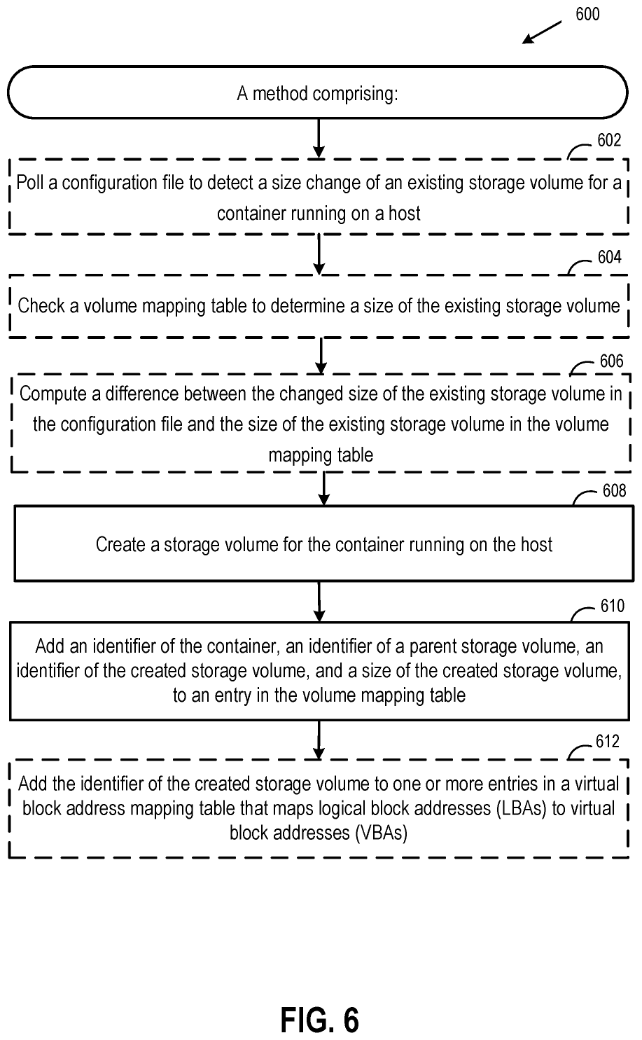

FIG. 6 depicts an example call flow illustrating operations 600 for container volume expansion in a virtual environment (e.g., network environment 100), according to one or more embodiments. Operations 600 may be performed by the components illustrated in FIG. 1 and FIG. 3 (e.g., container 202, pod VM agent 206, container agent 208, and container volume driver 154).

Operations 600 may begin, optionally, at operation 602, by polling a configuration file (e.g., configuration file 105) to detect a size change (e.g., to 5 GB) of an existing storage volume (e.g., base disk 212₁) for a container (e.g., container 202₁) running on a host (e.g., host 130).

Operations 600 may include, optionally, at operation 604, checking a volume mapping table (e.g., volume mapping table 218) to determine a size of the existing storage volume (e.g., 3 GB).

Operations 600 may include, optionally, at operation 606, computing a difference (e.g., 2 GB) between the changed size of the existing storage volume in the configuration file and the size of the existing storage volume in the volume mapping table.

Operations 600 include, at operation 608, creating a storage volume (e.g., delta disk 214₄) for the container running on the host. In some embodiments, the size of the created storage volume is equal to the difference computed at operation 606. In some embodiments, the container is active throughout the creation of the storage volume.

Operations 600 include, at operation 610, adding an identifier of the container (e.g., containerUUID1), an identifier of a parent storage volume (e.g., volUUID1), an identifier of the created storage volume (e.g., deltaUUID4), and a size of the created storage volume (e.g., 2 GB), to an entry in the volume mapping table. In some embodiments, the parent storage volume is existing storage volume.

In some embodiments, the identifier of the parent storage volume and the identifier of the created storage volume in the volume mapping table are the same when the created storage volume is a base disk. In some embodiments, the identifier of the parent storage volume and the identifier of the created storage volume in the volume mapping table are different when the created storage volume is a delta disk.

Operations 600 may include, optionally, at operation 612, adding the identifier of the created storage volume to one or more entries in a virtual block address mapping table (e.g., virtual LBA table 220) that maps LBAs to VBAs.

Operations 600 may further include operations for I/O request handling (not shown). In some embodiments, operations 600 may include receiving an I/O request from the container; determining an LBA associated with the I/O request; checking the virtual block address mapping table to identify the VBA and the identifier of a storage volume where the VBA is located; checking the volume mapping table for an entry containing the identifier of the storage volume and the identifier of the container; and executing the I/O request at the VBA when the volume mapping table contains the entry containing the identifier of the storage volume and the identifier of the container.

The embodiments described herein provide a technical solution to a technical problem associated with container expansion in a virtualized environment. More specifically, implementing the embodiments herein provides an approach for scalable containers allowing stateful container volumes to be expanded without bringing down the container, thereby reducing overhead associated with the container volume expansion.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method comprising:
detecting a size change of an existing storage volume for a container running on a host;
checking a volume mapping table to determine a size of the existing storage volume;
computing a difference between the changed size of the existing storage volume and the size of the existing storage volume in the volume mapping table;
creating a storage volume for the container, wherein the size of the created storage volume is at least equal to the difference; and
adding an identifier of the container, an identifier of the existing storage volume, an identifier of the created storage volume, and a size of the created storage volume, to an entry in the volume mapping table.

2. The method of claim 1, further comprising:
polling a configuration file to detect the size change of the existing storage volume for the container.

3. The method of claim 1, wherein the volume mapping table contains another entry with a first identifier of another existing storage volume and a second identifier of another created storage volume, wherein the other created storage volume is a base persistent container volume, and wherein the first identifier and the second identifier are the same.

4. The method of claim 1, wherein the created storage volume is a delta persistent container volume, and wherein the identifier of the existing storage volume and the identifier of the created storage volume in the volume mapping table are different.

5. The method of claim 1, further comprising adding the identifier of the created storage volume to one or more entries in a virtual block address mapping table that maps logical block addresses (LBAs) to virtual block addresses (VBAs).

6. The method of claim 5, further comprising:
receiving an input/output (I/O) request from the container;
determining an LBA associated with the I/O request;
checking the virtual block address mapping table to identify the VBA and the identifier of a storage volume where the VBA is located; and
checking the volume mapping table for an entry containing the identifier of the storage volume and the identifier of the container.

7. The method of claim 6, further comprising:
executing the I/O request at the VBA when the volume mapping table contains the entry containing the identifier of the storage volume and the identifier of the container.

8. The method of claim 1, wherein the container is active throughout the creating of the storage volume.

9. A system comprising:
one or more processors; and
at least one memory, the one or more processors and the at least one memory configured to:
detect a size change of an existing storage volume for a container running on a host;
check a volume mapping table to determine a size of the existing storage volume;
compute a difference between the changed size of the existing storage volume and the size of the existing storage volume in the volume mapping table;
create a storage volume for the container, wherein the size of the created storage volume is at least equal to the difference; and
add an identifier of the container, an identifier of the existing storage volume, an identifier of the created storage volume, and a size of the created storage volume, to an entry in the volume mapping table.

10. The system of claim 9, wherein the one or more processors and the at least one memory are configured to:
poll a configuration file to detect the size change of the existing storage volume for the container.

11. The system of claim 9, wherein the identifier of the parent storage volume and the identifier of the created storage volume in the volume mapping table are the same when the created storage volume is a base disk, and wherein the identifier of the parent storage volume and the identifier of the created storage volume in the volume mapping table are different when the created storage volume is a delta disk.

12. The system of claim 9, wherein the created storage volume is a delta persistent container volume, and wherein the identifier of the existing storage volume and the identifier of the created storage volume in the volume mapping table are different.

13. The system of claim 9, wherein the one or more processors and the at least one memory are configured to:
add the identifier of the created storage volume to one or more entries in a virtual block address mapping table that maps logical block addresses (LBAs) to virtual block addresses (VBAs).

14. The system of claim 13, wherein the one or more processors and the at least one memory are configured to:
receive an input/output (I/O) request from the container;
determine an LBA associated with the I/O request;
check the virtual block address mapping table to identify the VBA and the identifier of a storage volume where the VBA is located; and
check the volume mapping table for an entry containing the identifier of the storage volume and the identifier of the container.

15. The system of claim 14, wherein the one or more processors and the at least one memory are configured to:
execute the I/O request at the VBA when the volume mapping table contains the entry containing the identifier of the storage volume and the identifier of the container.

16. The system of claim 9, wherein the container is active throughout the creating of the storage volume.

17. A non-transitory computer-readable medium comprising instructions that, when executed by one or more processors of a computing system, cause the computing system to perform operations, the operations comprising:
detect a size change of an existing storage volume for a container running on a host;
checking a volume mapping table to determine a size of the existing storage volume;
computing a difference between the changed size of the existing storage volume and the size of the existing storage volume in the volume mapping table;
creating a storage volume for the container, wherein the size of the created storage volume is at least equal to the difference; and
adding an identifier of the container, an identifier of the existing storage volume, an identifier of the created storage volume, and a size of the created storage volume, to an entry in the volume mapping table.

18. The non-transitory computer-readable medium of claim 17, the operations further comprising:
polling a configuration file to detect the size change of the existing storage volume for the container.

19. The non-transitory computer-readable medium of claim 17, wherein the volume mapping table contains another entry with a first identifier of another existing storage volume and a second identifier of another created storage volume, wherein the other created storage volume is a base persistent container volume, and wherein the first identifier and the second identifier are the same.

20. The non-transitory computer-readable medium of claim 17, wherein the created storage volume is a delta persistent container volume, and wherein the identifier of the existing storage volume and the identifier of the created storage volume in the volume mapping table are different.
